(19) United States
(12) Patent Application Publication
(10) Pub. No.: US 2007/0234630 A1
(43) Pub. Date: Oct. 11, 2007

(54) FISHING ROD HOLDER

(76) Inventors: Marcellus Williams, Hampton, VA (US); Miguel A. Morales, Hampton, VA (US)

Correspondence Address: LAW OFFICE OF MICHAEL A. BLAKE, 112 BROAD STREET, MILFORD, CT, 06460, US

(21) Appl. No.: 11/278,826

(22) Filed: Apr. 6, 2006

(51) Int. Cl. A01K 97/10

(52) U.S. Cl. 43/21.2

(57) ABSTRACT

The disclosed invention relates to a fishing rod holder comprising: a generally cylindrical base with a top and a bottom, and wherein the top is open and bottom is closed; a neck in communication with the base; a clip located near a top of the neck; a first slot located generally on the base; a second slot located generally on the base; and where the base is configured to hold a fishing rod handle, and the clip is configured to hold a fishing rod.

### TECHNICAL FIELD

The present invention relates to fishing rod holders, and more particularly to fishing rod holders which mount removably with respect to a fisherman's clothing.

### BACKGROUND

Fishing is an activity that is ever increasing in popularity. Many men, women and children spend hours fishing. However, these fishing enthusiasts are frequently subjected to discomfort caused by the fishing rod handle digging into their bodies, near their waist or abdomen. Additionally, fishing enthusiasts may become fatigued by holding a fishing rod for long periods of time. Also, it may be difficult to bait a hook, cut bait, and/or net a fish while holding on to a fishing rod.

Thus, there is a need to provide a device which can overcome the above listed and other disadvantages.

### SUMMARY

The disclosed invention relates to a fishing rod holder comprising: a generally cylindrical base with a top and a bottom, and wherein the top is open and bottom is closed; a neck in communication with the base; a clip located near a top of the neck; a first slot located generally on the base; a second slot located generally on the base; and where the base is configured to hold a fishing rod handle, and the clip is configured to hold a fishing rod.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a front view of the disclosed fishing rod holder;

FIG. 2 is a side view of the disclosed fishing rod holder from FIG. 1; and

FIG. 3 is a top view of the disclosed fishing rod holder from FIG. 1.

### DETAILED DESCRIPTION

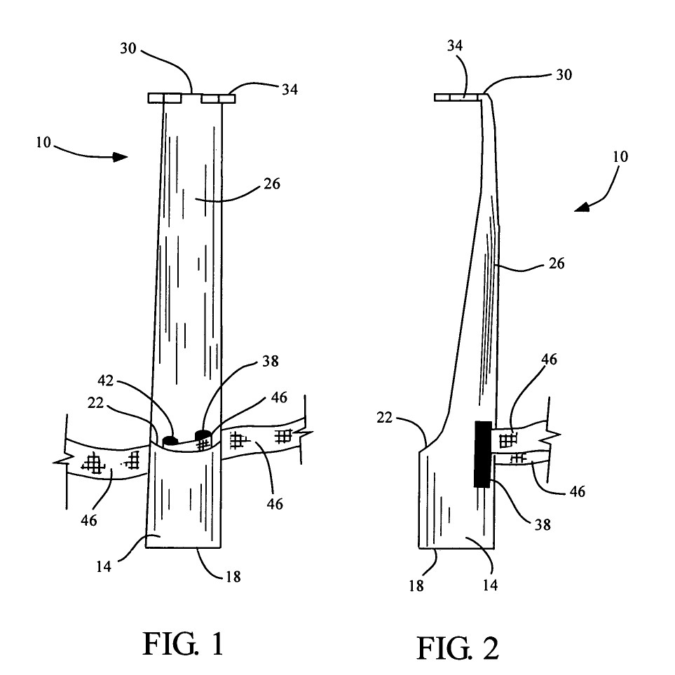

FIG. 1 is a front view of the disclosed fishing rod holder 10. The rod holder 10 comprises a generally cylindrical base 14 that is closed at a base bottom 18 and opened at a base top 22. In communication with the base 14 is a neck 26. At or near a neck top 30 is located a clip 34. Located generally on the same side of the generally cylindrical base 14 as the neck 26 are two slots 38, 42. A belt 46 is shown weaved through the two slots 38, 42. The slots 38, 42 are generally located in the base 14, but may extend into the neck 26. The slots 38, 42 may be staggered, that is, one slot 38 may be slightly higher than the other slot 42. In operation the fishing rod holder 10 is attached to a person's belt via the slots 38, 42. Although attaching to a belt is a preferred embodiment, the fishing rod holder may be attached via straps, ropes, ties, or any other means of weaving an attaching means through the slots 38, 42. Once attached, a fishing rod may be placed in the fishing rod holder 10, the handle of the fishing rod is placed in the generally cylindrical base 14 with the rod being clipped into the clip 34, thereby holding the fishing rod securely. The base 14 may be about 2 to about 8 inches in height, the neck 26 may be about 8 to about 16 inches in height. The cylindrical base 14 may have a diameter of about 1 to about 4 inches. The rod holder 10 may be made out of one piece of plastic through a relatively inexpensive manufacturing process such as, but not limited to Injection Molding; Blow Molding; Thermoforming; Compression Molding; Transfer Molding; Reaction Injection Molding; and Extrusion. Additionally, the rod holder 10, may be made out of other materials such as but not limited to: metal, fiberglass, and wood.

FIG. 2 is a side view of the disclosed fishing rod holder 10. In this view only one slot 38 is visible. A portion of the belt 46 is shown exiting slot 38, and a portion of the belt 46 is shown exiting slot 42 (slot 42 not visible). The neck 26 may have a slight curve as shown in FIG. 2.

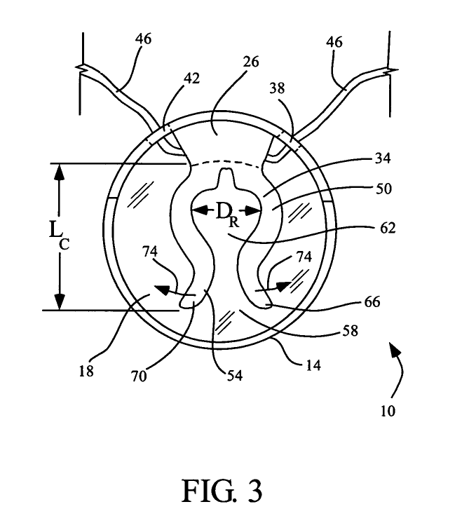

FIG. 3 is a top view of the disclosed fishing rod holder 10. The clip 34 is visible in great detail in this figure. The clip 34 comprises two curved, generally sinusoidal, elements 50, 54. The elements 50, 54, extend from the neck 26, and have a length L_{C} of about 0.5 to about 2 inches, and preferably about 1 inch. The two elements 50, 54 flare out to form a clip opening 58 for a fishing rod to slide through. The two elements 50,54 form a generally circular rod hole 62 where the fishing rod is held in place. The generally circular rod hole 62 has a diameter D_{R} of about 0.25 to about inch, and preferably about 0.5 inch. In operation, as a fishing rod slides into the clip opening 58, the flared ends 66, 70 of the two elements 50, 54, flex outwardly in the direction shown by the arrows 74, to allow a fishing rod entrance to the rod hole 62. Once the fishing rod passes the clip opening 58 into the rod hole 62, the flared ends 66, 70 resume their normal at rest configuration, and hold the fishing rod in the rod hole 62. Slots 38 and 42 are represented by dotted lines in this figure.

The disclosed fishing rod holder has many advantages, it allows a fishing enthusiast to holster a fishing rod giving him or her the freedom to use their hands to handle fish and re-bait the fishing hook. The fishing rod holder may be made out of plastic in an inexpensive manufacturing process and may be lightweight. Additionally, using the fishing rod holder may relieve the fishing enthusiast from fatigue due to holding the fishing rod, and from having the fishing rod poke into the fishing enthusiast's body.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A fishing rod holder comprising:
a generally cylindrical base with a top and a bottom, and wherein the top is open and bottom is closed;
a neck in communication with the base;
a clip located near a top of the neck;
a first slot located generally on the base;
a second slot located generally on the base; and
wherein the base is configured to hold a fishing rod handle, and the clip is configured to hold a fishing rod.

2. The fishing rod holder of claim 1, wherein the clip comprises:
a first generally sinusoidal element with a first flared end;
a second generally sinusoidal element with a second flared end;
a clip opening formed by the first flared end and the second flared end;
a rod hole formed by the first generally sinusoidal element and the second generally sinusoidal element.

3. The fishing rod holder of claim 1, wherein the first slot is located generally lower on the base than the second slot.

4. The fishing rod holder of claim 1, wherein
the base is about 2 inches to about 8 inches in height;
the base has a diameter of about 1 inch to about 4 inches;
the neck is about 8 inches to about 16 inches in height; and
the clip extends from the neck by about 0.5 inches to about 2 inches.

5. The fishing rod holder of claim 1, wherein the fishing rod holder is made out of one piece of plastic.

6. The fishing rod holder of claim 1, wherein the fishing rod holder is manufactured by a means selected from the group comprising: Injection Molding; Blow Molding; Thermoforming; Compression Molding; Transfer Molding; Reaction Injection Molding; and Extrusion.

7. The fishing rod holder of claim 1, wherein the first slot and second slot are configured to have a belt weaved through the slots and hold the fishing rod holder against a body of a user.

8. The fishing rod holder of claim 1, wherein the fishing rod holder is configured to have a fishing rod snap into the clip prior to use and snap out of clip when no longer in use.
